(19) United States
(12) Patent Application Publication
(10) Pub. No.: US 2026/0307385 A1
(43) Pub. Date: Oct. 8, 2026

(54) PRINTING APPARATUS, CONTROL METHOD, AND STORAGE MEDIUM

(71) Applicant: CANON KABUSHIKI KAISHA, Tokyo (JP)

(72) Inventor: YUSHI SUEMATSU, Kanagawa (JP)

(21) Appl. No.: 19/570,357

(22) Filed: Mar. 18, 2026

(30) Foreign Application Priority Data
Apr. 8, 2025 (JP) 2025-063921

(51) Int. Cl. B41J 2/045

(52) U.S. Cl. CPC B41J 2/04563; B41J 2/0451; B41J 2/04515; B41J 2/04528; B41J 2/04551; B41J 2/04573; B41J 2202/08

(57) ABSTRACT

A printing apparatus performs first processing of waiting by until a detected temperature of a printing unit after a refreshing operation detected by a temperature detection unit becomes equal to or lower than a predetermined threshold temperature, performs second processing in which the refreshing operation and the first processing are repeated a second number of times, counts a cumulative value of a wait time in the second processing, and determines that it is difficult to eject a liquid in a case where the cumulative value in the second processing becomes equal to or more than a threshold.

### BACKGROUND

### Field of the Technology

The present disclosure relates to a printing apparatus, a control method, and a storage medium.

### Description of the Related Art

With a printing apparatus having a printing section that ejects a liquid onto a printing medium, the state of ejection of the liquid by the printing section may be detected.

U.S. Patent Application Publication No. 2010/0295882 specification discloses a printing apparatus that determines that an error is occurring in a printing section for ejecting a liquid in a case where the temperature of the printing section is equal to or higher than a normal temperature by a predetermined temperature and determines that the printing section is normal otherwise. The printing apparatus according to U.S. Patent Application Publication No. 2010/0295882 specification previously stores the normal temperature of the printing section in the case where printing elements are driven at a predetermined frequency to cause liquid ejection, and drives the printing elements at the predetermined frequency after the printing section is heated to the stored normal temperature.

However, if the presence or absence of an error is detected based only on the amount of a single change in temperature of the printing section as with the printing apparatus disclosed in U.S. Patent Application Publication No. 2010/0295882 specification, erroneous detection may occur because of the influence of an accidental change in a printing head. For example, an ejection failure due to a rapid increase in temperature of the printing section that is caused by sudden bubbling and eliminated in a relatively short time as the bubbling stops may be erroneously detected as an error.

Furthermore, in the printing apparatus disclosed U.S. Patent Application Publication No. 2010/0295882 specification, a temperature unevenness may occur in the printing head immediately after the printing head is heated. Therefore, if the presence or absence of an error is detected based only on the amount of a single change in temperature of the printing section, erroneous detection of an error may occur because of the influence of the unstable heat transfer in the early stage of operation.

Furthermore, in a case where the ambient environmental temperature of the printing apparatus is high, the temperature of the printing section is also high. As a result, the normal temperature referred to by the printing apparatus disclosed in U.S. Patent Application Publication No. 2010/0295882 specification in a case where detecting the presence or absence of an error is an even higher temperature. Therefore, the printing apparatus disclosed in U.S. Patent Application Publication No. 2010/0295882 specification may erroneously detect an error in the printing section.

### SUMMARY

The present disclosure is to provide a printing apparatus that can precisely detect the state of ejection of a liquid by a printing section.

A printing apparatus has: a printing unit of ejecting a liquid; a temperature detection unit of detecting a temperature of the printing unit; a refreshing unit of performing a refreshing operation in which the printing unit ejects the liquid at a predetermined frequency; a first processing execution unit of performing first processing of waiting by until a detected temperature of the printing unit after the refreshing operation detected by the temperature detection unit becomes equal to or lower than a predetermined threshold temperature; a second processing execution unit of performing second processing in which the refreshing operation and the first processing are repeated a first number of times; a counting unit of counting a cumulative value of a wait time in the second processing; and a determination unit of determining that the printing unit is in a state where it is difficult to eject the liquid in a case where the cumulative value in the second processing becomes equal to or more than a threshold.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic perspective view of a printing apparatus according to an embodiment;

FIG. 2A is a schematic perspective view of a first printing head;

FIG. 2B is a schematic bottom view of the first printing head;

FIG. 2C is an enlarged view of a first nozzle array;

FIG. 3 is a block diagram showing the printing apparatus according to the embodiment;

FIG. 4 is a diagram for illustrating an example of AD conversion in the printing head according to the embodiment;

FIG. 5 is a flowchart including recovery processing according to the embodiment;

FIG. 6 is a diagram showing a subroutine of S502;

FIG. 7A is a diagram showing an example of a first support screen;

FIG. 7B is a diagram showing an example of a second support screen;

FIG. 7C is a diagram showing an example of a third support screen;

FIG. 8 is a diagram showing a subroutine of S508;

FIG. 9 is a diagram showing a modification of FIG. 5;

FIG. 10 is a flowchart showing an example of a refreshing process according to an embodiment;

FIG. 11 is a flowchart including transition processing to a no-ink mode;

FIG. 12 is a diagram showing a subroutine of S1101;

FIG. 13 is a diagram showing an example of a selection screen according to the embodiment;

FIG. 14 is a diagram showing an example of a guide screen according to the embodiment;

FIG. 15A is a diagram showing a first modification of S1013;

FIG. 15B is a flowchart showing a second modification of S1013;

FIG. 16 is a diagram showing a modification of S1101; and

FIG. 17 is a diagram showing an example of a protective tape detection process according to an embodiment.

### DESCRIPTION OF THE EMBODIMENTS

### First Embodiment

### Printing Apparatus 100

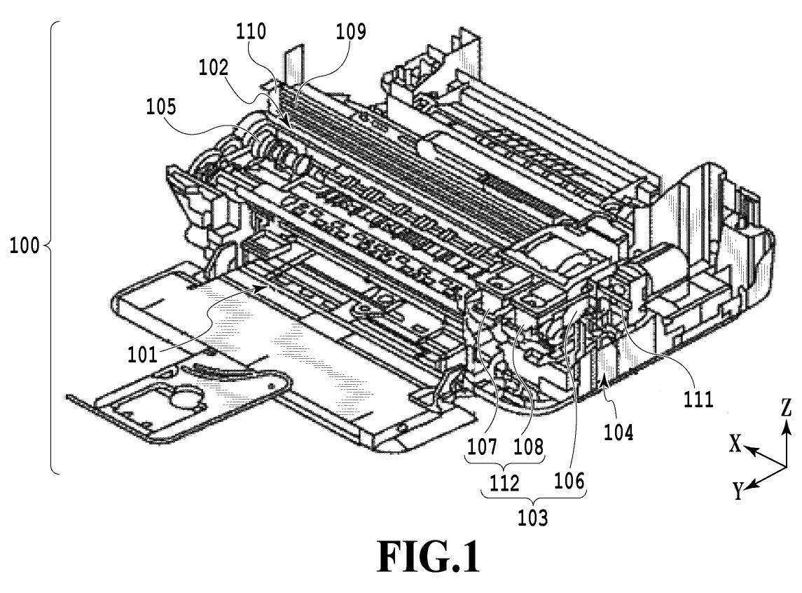

FIG. 1 is a schematic perspective view showing a part of an internal configuration of a printing apparatus 100 according to a first embodiment.

As shown in FIG. 1, the printing apparatus 100 includes a feeding section 101 that feeds a printing medium, a conveying section 102 that conveys the printing medium, a printing section 103 that performs printing on the printing medium and a recovery section 104 that recovers the performance of the printing section 103. The printing section 103 includes a carriage 106 that can move back and forth in an X direction (scanning direction) that intersects with a Y direction (conveyance direction of the printing medium), and a first printing head 107 and a second printing head 108 mounted on the carriage 106. The first printing head 107 ejects color ink, and the second printing head 108 ejects black ink.

In the following, the first printing head 107 and the second printing head 108 will be referred to simply as a printing head 112, unless the printing heads 107 and 108 need to be distinguished from each other. Note that in the printing apparatus 100 according to this embodiment, a disposable printing head 112 having a print head and an ink tank integrated with each other is used as the printing head 112.

The feeding section 101 supplies a printing medium into an apparatus main body. The conveying section 102 conveys the printing medium supplied by the feeding section 101 in the Y direction (conveyance direction). The printing section 103 prints an image on the printing medium based on image information. The recovery section 104 performs a recovery operation for maintaining the ink ejection performance of the printing head 112, in order to keep the quality of the printed image.

The feeding section 101 feeds printing media into the apparatus main body. The printing media placed on the feeding section 101 is picked up one by one by a pickup roller and a sheet feeding roller (not shown) driven by a sheet feeding motor (not shown), sent out and fed to the conveying section 102. A detecting sensor (not shown) is provided upstream of a conveyance roller 105. In a case where the front edge of the printing medium passes by the detecting sensor, the detecting sensor can detect the passing.

The conveying section 102 conveys the printing medium supplied by the feeding section 101. The printing medium fed to the conveying section 102 is pinched between the conveyance roller 105 driven by a conveying motor (not shown) and a pinch roller (not shown) and conveyed through a region in which the printing section 103 can perform printing on the printing medium.

The printing section 103 prints an image by ejecting ink onto the printing medium from a printing head 112 based on image data.

The carriage 106 is supported such that the carriage 106 can move back and forth in the X direction along a guide rail 111 provided in the printing apparatus 100. In a case where performing printing on the printing medium, the carriage 106 is moved back and forth in the ±X direction in a printing region by a carriage belt 109 rotated by a carriage motor (not shown).

The position and speed of the carriage 106 are detected with an encoder sensor (not shown) mounted on the carriage 106 and an encoder scale 110 stretched in the printing apparatus 100, and the movement of the carriage 106 is controlled based on the position and the speed. Printing on the printing medium is performed by ejecting ink from the printing head 112 while the carriage 106 is moving.

The printing medium is pinched between a discharge roller (not shown) driven in synchronization with the conveyance roller 105 by the conveying section 102 and a driven roller (not shown) pressed against the discharge roller and discharged to the outside of the printing apparatus. In a case where the rear edge of the printing medium passes by the detecting sensor (not shown) described above, the detecting sensor can detect the passing.

The recovery section 104 includes a wiping mechanism that wipes ink drops off a surface of the printing head 112 in which nozzles are formed (nozzle surface), thereby recovering a normal state of the nozzle surface. In addition to the wiping mechanism, the recovery section 104 includes a capping mechanism that covers the nozzles, a suction mechanism that sucks ink from the nozzles capped by the capping mechanism, and the like.

The printing head 112 includes a plurality of printing elements for ejecting ink. The printing apparatus 100 prints an image on the printing medium by ejecting ink onto the printing medium by driving the printing elements while moving the carriage 106 with the printing section 103 mounted thereon. These printing elements are provided at positions corresponding to a plurality of nozzles formed in the printing head 112. Ejection of ink is achieved by driving the printing elements to push the ink out of the nozzles.

As a method of ejecting ink, the thermal inkjet type is known in which ink is pushed out by using the bubbling pressure of the ink undergoing a phase transition in a case where the ink is heated with a heat generating element, such as a heater. In order to achieve an excellent printing quality, the nozzles and the printing elements need to be kept in an excellent condition.

For example, ink in the nozzle is exposed to the outside air. Therefore, volatile substances in the ink in the nozzle gradually evaporate. In general, the main component of the ink is water. Therefore, evaporation of water of the ink in the nozzle can be a great problem. As evaporation of water of the ink in the nozzle proceeds, the viscosity of the ink in the nozzle increases to cause an ejection failure or sticking in the nozzle. To solve such problems, the recovery section 104 performs a recovery operation.

An example of the recovery operation is a capping operation of covering the nozzles of the printing head 112 with a cap to prevent evaporation of the ink from the nozzles. Examples of the recovery operation other than the capping operation include a refreshing operation of driving the printing elements to discharge ink having an increased viscosity, a suction recovery operation of sucking ink with a pump, and a wiping operation of wiping stains off the nozzles and their periphery, for example.

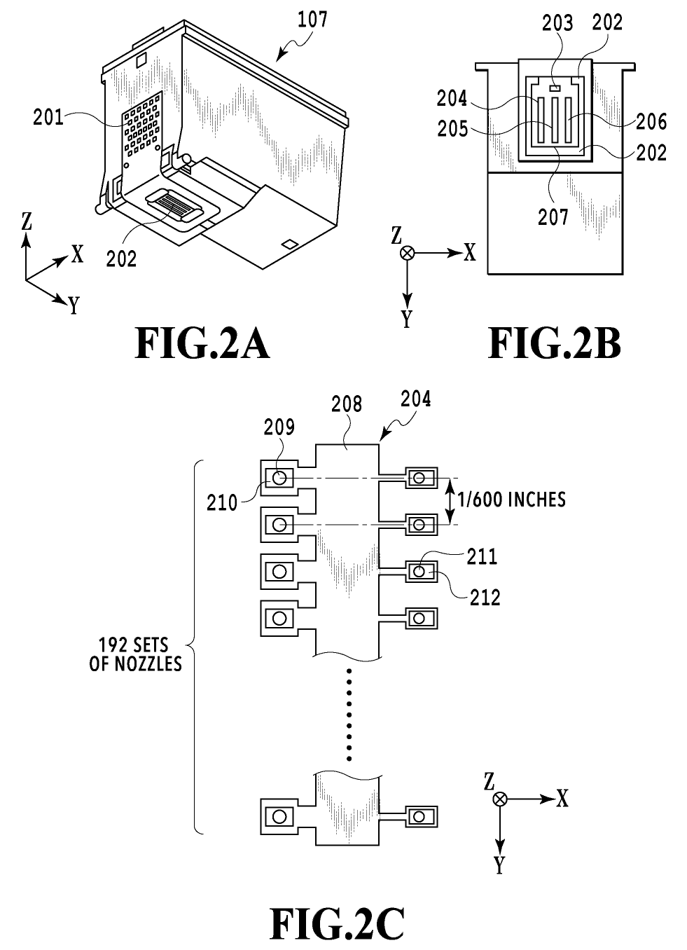

FIG. 2A is a schematic perspective view of the first printing head 107. FIG. 2B is a schematic bottom view of the first printing head 107 viewed in a Z direction. FIG. 2C is an enlarged view of a first nozzle array 204 of the first printing head 107.

Note that the first printing head 107 and the second printing head 108 have the same configuration. Therefore, in the description with reference to FIGS. 2A to 2C, descriptions of the configuration of the second printing head 108 will be omitted.

As shown in FIGS. 2A to 2C, the first printing head 107 includes a contact pad 201 for receiving an electric signal and a printing chip 202 for ejecting ink. At the contact pad 201, the first printing head 107 receives a printing signal from the main body of the printing apparatus 100 and is supplied with electric power required to drive the first printing head 107.

In the printing chip 202, a diode sensor 203 that detects the temperature of a substrate included in the printing chip 202 is provided. In the printing chip 202, a first nozzle array 204 for ejecting cyan ink, a second nozzle array 205 for ejecting magenta ink, and a third nozzle array 206 for ejecting yellow ink are provided.

In the printing chip 202, a sub-heater 207 for heating ink is provided to surround the first nozzle array 204, the second nozzle array 205, and the third nozzle array 206. In a case where a voltage is applied to the sub-heater 207, the printing chip 202 and the ink are heated.

On the opposite sides of an ink chamber 208 of the first nozzle array 204, first nozzles 209 that eject 5 pl of ink and second nozzles 211 that eject 2 pl of ink are provided. A first ejection heater 210 for ejecting 5 pl of ink is provided directly above (in the +Z direction) each first nozzle 209. A second ejection heater 212 for ejecting 2 pl of ink is provided directly above (in the +Z direction) each second nozzle 211.

The number of the first nozzles 209 and the number of the second nozzles 211 are 192. The distance between the 192 nozzles is 1/600 inches. Thus, the first printing head 107 according to this embodiment is configured such that the printed pixel density is 600 dpi. In a case where a driving pulse that does not cause ejection of ink is applied to the first ejection heater 210 and the second ejection heater 212, the first ejection heater 210 and the second ejection heater 212 can keep the ink warm. In the following, this heat conservation control will be referred to as a "short pulse heating control" as required.

The printing apparatus 100 according to this embodiment (see FIG. 1) adjusts the temperature of the printing chip 202 and the temperature of the ink (these temperatures will be collectively referred to as a "head temperature" as required) by the short pulse heating control and control of the sub-heater.

Specifically, feedback control is performed by heating and stopping heating the printing chip 202 in a switched manner so as to bring the head temperature close to a preset target temperature value based on an output value from the diode sensor 203. The second printing head 108 (see FIG. 1) is subjected to the same feedback control as the first printing head 107.

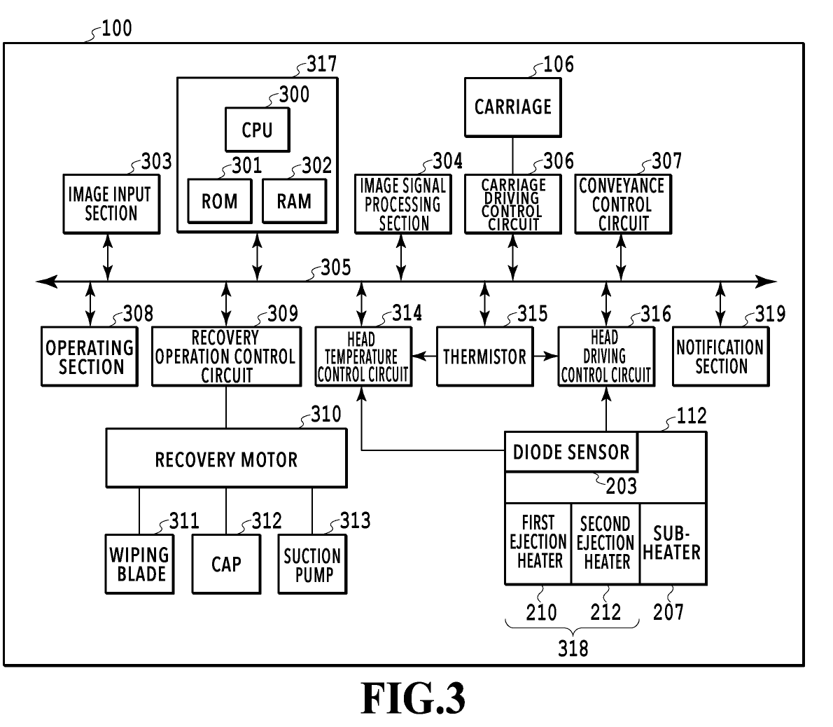

FIG. 3 is a block diagram showing a general control configuration of the printing apparatus 100 according to this embodiment.

As shown in FIG. 3, components of the control configuration according to this embodiment are generally divided into software-based control elements and hardware-based processing elements.

The software-based control elements include an image input section 303 for receiving an image, an image signal processing section 304 associated with the image input section 303, and a control section 317 that serves as a central control section. The image input section 303, the image signal processing section 304, and the control section 317 each access a main bus line 305.

On the other hand, the hardware-based processing elements include an operating section 308 for receiving an operation from a user, a recovery operation control circuit 309 for controlling the recovery operation, and a head temperature control circuit 314 for controlling the head temperature. The hardware-based processing elements further includes a head driving control circuit 316 for controlling driving of the printing head 112 and a carriage driving control circuit 306 for controlling driving of the carriage 106 that moves in a main scanning direction.

The hardware-based processing elements further includes a conveyance control circuit 307 for controlling conveyance of the printing medium in a sub-scanning direction and a notification section 319 that notifies the user of the possibility that an error is occurring in the printing head 112.

The control section 317 includes a CPU 300, a ROM 301, and a RAM 302. The CPU 300 provides a printing condition appropriate to input information to drive the first ejection heater 210 and the second ejection heater 212 of the printing head 112 for printing.

In the following, the first ejection heater 210 and the second ejection heater 212 will be referred to simply as an "ejection heater 318", unless the first ejection heater 210 and the second ejection heater 212 need to be distinguished from each other.

In the ROM 301, a program for implementing a recovery timing chart for the printing head 112 is stored. This program provides a recovery condition, such as a preliminary ejection condition, to the recovery operation control circuit 309 and the printing head 112 as required.

A recovery motor 310 drives a wiping blade 311, a cap 312, and a suction pump 313 that are opposed to and spaced apart from the first printing head 107. The recovery motor 310 drives a wiping blade 311, a cap 312, and a suction pump 313 that are opposed to and spaced apart from the second printing head 108.

The head temperature control circuit 314 determines a driving condition for the sub-heater 207 of the first printing head 107 and a driving condition for the sub-heater 207 on the second printing head 108. The driving condition for the sub-heater 207 of the first printing head 107 is determined based on output values from a thermistor 315 that detects an environmental temperature, which is the temperature of the periphery of the printing head 112, and the diode sensor 203 that detects the temperature of the printing head 112.

On the other hand, the driving condition for the sub-heater 207 on the second printing head 108 is determined based on output values from a thermistor 315 that detects an environmental temperature, which is the temperature of the periphery of the second printing head 108, and the diode sensor 203 that detects the temperature of the second printing head 108. The head driving control circuit 316 drives the sub-heater 207 based on the determined driving condition.

The head driving control circuit 316 also drives the ejection heater 318 of each printing head 112. By the ejection heaters 318 being driven, the printing head 112 performs preliminary ejection, ink ejection for printing, and ink temperature adjustment control for adjusting the temperature of the ink. An example of the site where a program for performing the ink temperature adjustment control is stored is the ROM 301. In a case where the program is executed, the program makes the head temperature control circuit 314 or the like perform detection of the head temperature or the like and makes the head driving control circuit 316 or the like perform driving of the sub-heater 207 or the like.

Note that the head driving control circuit 316 can drive the ejection heaters 318 with a drive signal including a pre-pulse and a main pulse and perform pulse width modulation (PWM) control.

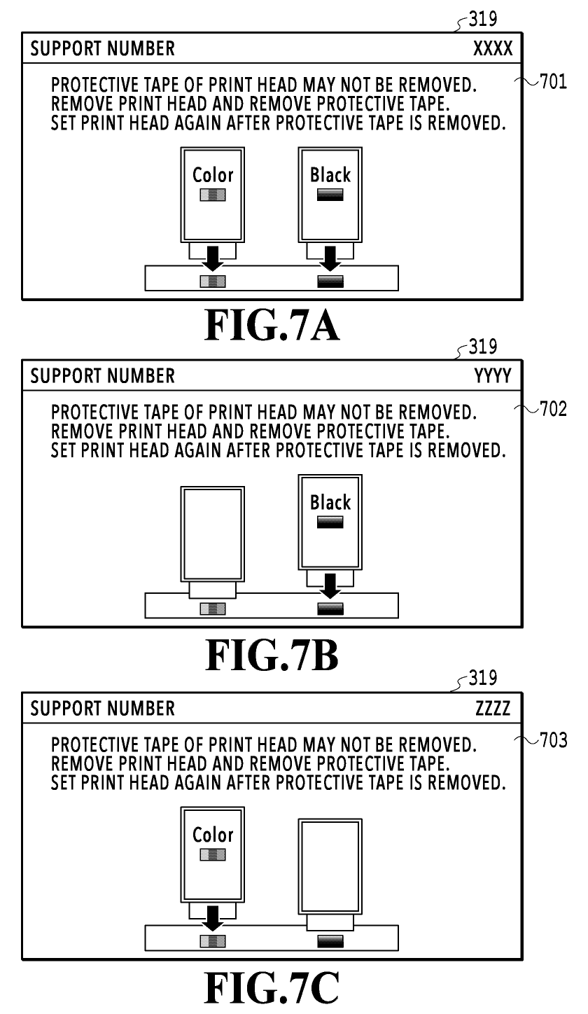

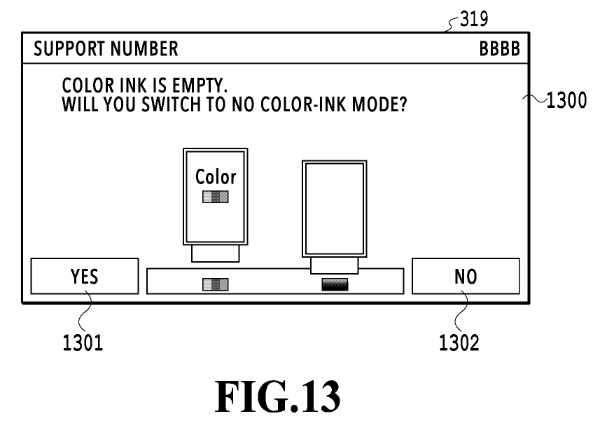

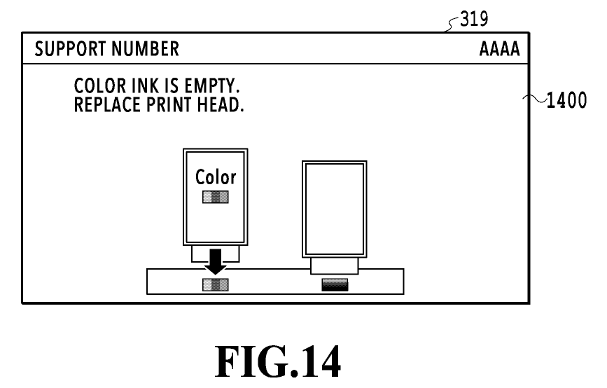

The notification section 319 is configured to be able to notify the user of the possibility that an error is occurring in the printing head 112. For example, the notification section 319 includes a liquid crystal panel. On the liquid crystal panel, for example, a text or the like indicating that there is a possibility that a protective tape for protecting the printing head 112 is not removed (see FIGS. 7A to 7C). In another example, a text or the like indicating that there is a possibility that there is no remaining ink (see FIGS. 13 and 14).

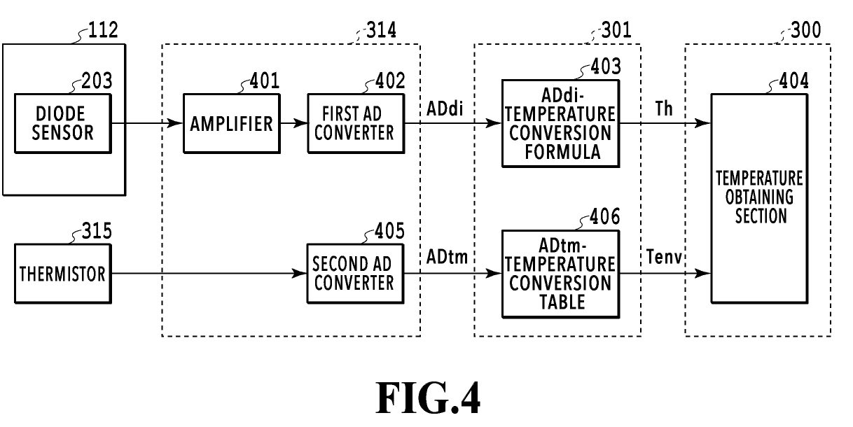

FIG. 4 is a diagram for illustrating analog-to-digital conversion (AD conversion) in the printing head 112 according to this embodiment.

As shown in FIG. 4, the head temperature control circuit 314 includes an amplifier 401 that amplifies an input voltage value, a first AD converter 402 that converts an amplified analog signal into a digital signal, and a second AD converter 405 that performs a predetermined AD conversion.

In the ROM 301, an ADdi-temperature conversion formula 403 and an ADtm-temperature conversion table 406 are stored. In a case where a voltage value based on the head temperature detected by the diode sensor 203 provided in the printing head 112 is input to the head temperature control circuit 314, the amplifier 401 amplifies the voltage value. The amplified voltage value is digitized by the first AD converter 402. The diode sensor voltage value ADdi digitized by the first AD converter 402 is converted into a diode temperature Th by the ADdi-temperature conversion formula 403.

On the other hand, in a case where a voltage value based on the environmental temperature of the printing apparatus 100 detected by the thermistor 315 is input to the head temperature control circuit 314, the voltage value is digitized by the second AD converter 405. The thermistor voltage value ADtm digitized by the second AD converter 405 is converted into a thermistor temperature Tenv by the ADtm-temperature conversion table 406.

The diode temperature Th and the thermistor temperature Tenv obtained in the manner described above are input to a temperature obtaining section 404 and used for performing control including recovery processing (S508) for performing the recovery operation.

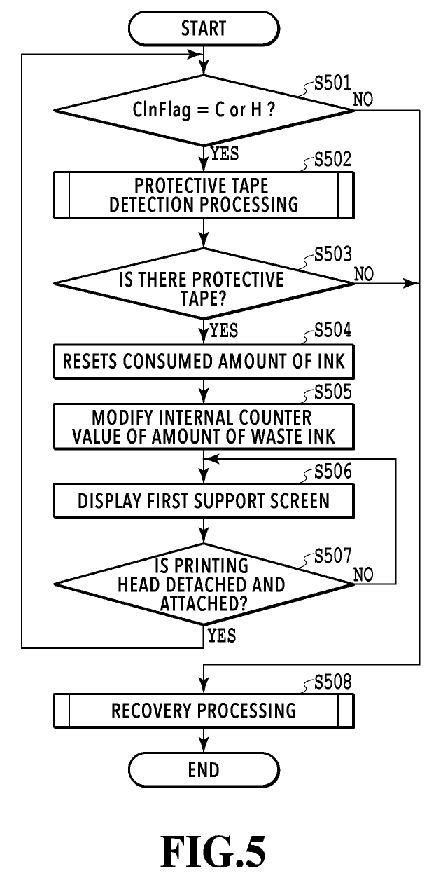

FIG. 5 is a flowchart including the recovery processing according to this embodiment. The process in the flowchart of FIG. 5 is performed on the whole of the printing apparatus 100 in a case where an indication from the user occurs or in a case where the CPU 300 determines that the recovery processing is needed.

The process shown in the flowchart of FIG. 5 is performed by the CPU 300 (see FIG. 3) deploying a control program stored in the ROM 301 (see FIG. 3) in the RAM 302 (see FIG. 3). The character "S" in the description of each processing means a step in the flowchart. This holds true for the other flowcharts.

As a premise, the printing head 112 is shipped in a state where all of the plurality of nozzles formed in the nozzle surface are covered by a protective tape for protection. In some cases, however, the user may forget to remove the protective tape. Therefore, the CPU 300 according to this embodiment performs protective tape detection processing as error detection processing in a case where the printing head 112 is used for the first time and the printing head 112 is replaced.

Furthermore, in the flowchart of FIG. 5, a cleaning flag "ClnFlag" for determining the type, the intensity, and the like of the recovery operation is set in a memory of the printing head 112 in a rewritable manner. The types of the cleaning flag include "C" and "H", for example. The printing head 112 is shipped in a state where "C" is stored in the ROM 301 as ClnFlag in advance.

Furthermore, the printing head 112 is configured such that "H" is set as ClnFlag in a case where the printing head 112 is removed from the carriage 106 (see FIG. 1) and mounted on the carriage 106 again. In this case, "H" is stored in the ROM 301 as ClnFlag. That is, with the printing apparatus 100 according to this embodiment, protective tape detection processing (S502) is performed in a case where the printing head 112 is used for the first time and in a case where the printing head 112 is replaced.

In S501, the CPU 300 refers to the type of ClnFlag and determines whether to perform the protective tape detection processing. In a case where ClnFlag indicates "C" or "H", the CPU 300 performs the processing of S502. On the other hand, in a case where ClnFlag indicates other types than "C" and "H", the CPU 300 performs the processing of S508.

In S502, the CPU 300 performs the protective tape detection processing.

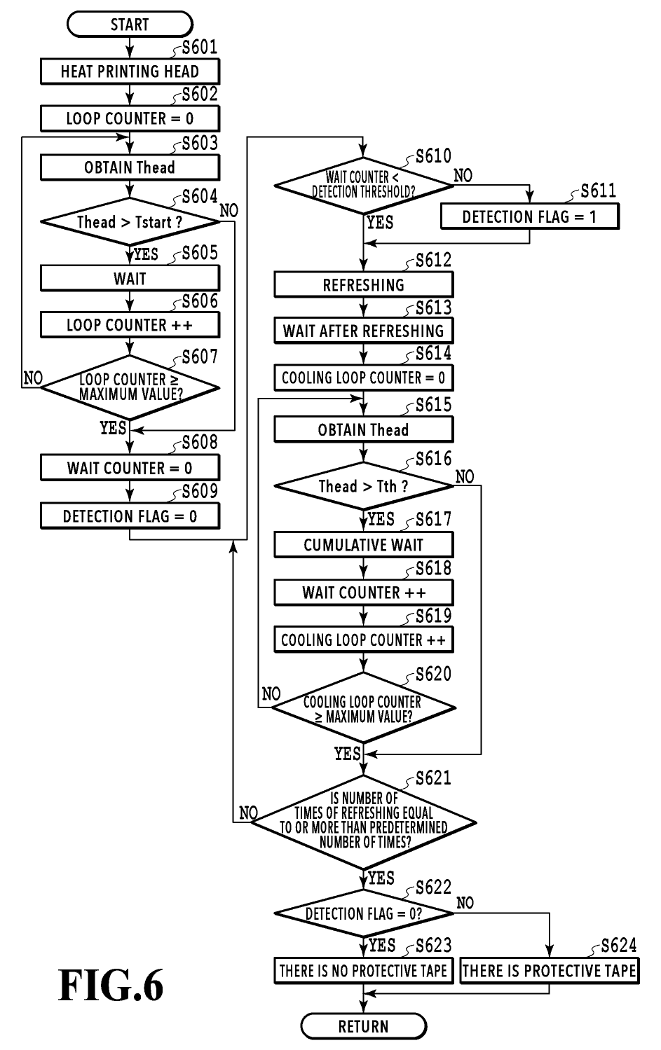

FIG. 6 is a diagram showing a subroutine of S502. The subroutine in FIG. 6 is performed on each of the first printing head 107 and the second printing head 108.

The protective tape detection processing according to this embodiment is generally divided into pre-heating control that corresponds to the processing from S601 to S607 and protective tape detection control that corresponds to the processing from S608 to S622. In the protective tape detection processing according to this embodiment, the printing head 112 (see FIG. 1) is heated before the presence or absence of the protective tape is detected.

The presence or absence of the protective tape can be detected without heating the printing head 112. However, by heating the printing head 112, the temperature of the printing head 112 is brought close to a normal temperature in the case where the refreshing operation is performed. As a result, the time required to detect the presence or absence of the protective tape and the amount of ink used to detect the presence or absence of the protective tape can be reduced. The pre-heating control will be first described.

In S601, the CPU 300 performs heating processing of heating the printing head 112 until the head temperature reaches a target temperature.

The target temperature value of the target temperature is preferably set to be close to a threshold (Tth) used in the processing of S616 described later. For example, the printing head 112 can be heated by continuously applying electric pulses that do not cause ejection of ink to the ejection heaters 318 (see FIG. 3). In this case, a temperature unevenness may occur in the printing head 112 immediately after the printing head 112 is continuously heated.

Therefore, the output value of the diode sensor 203 (see FIG. 2) may increase after the heating of the printing head 112 is stopped because heat is transferred from a part at a higher temperature to the part where the diode sensor 203 is provided. In view of this, in a first control, wait processing is performed until the head temperature decreases to a predetermined temperature or lower after S601 so that the temperature unevenness in the printing head 112 is eliminated.

In S602, the CPU 300 resets a loop counter value, which is a value for managing the number of waits. For example, "0" is set as the loop counter value.

In S603, the CPU 300 obtains a head temperature value (Thead) detected by the diode sensor 203.

In S604, the CPU 300 refers to the head temperature value (Thead) obtained in S603 and determines whether the head temperature value is higher than a temperature value (Tstart) that indicates that the detection processing can be started. In a case where Thead is higher than Tstart, the CPU 300 performs the processing of S605. On the other hand, in a case where Thead is equal to or lower than Tstart, the CPU 300 performs the processing of S608. That is, in a case where Thead is equal to or lower than Tstart, the pre-heating control is ended, and the protective tape detection control is started.

In S605, the CPU 300 performs wait processing for a predetermined time.

In S606, the CPU 300 increments the loop counter value that indicates the number of executions of the wait processing of S605.

In S607, the CPU 300 refers to the loop counter value incremented in S606, and determines whether the loop counter value is equal to or more than a predetermined maximum value. In a case where the loop counter value is equal to or more than the maximum value, the CPU 300 performs the processing of S608. On the other hand, in a case where the loop counter value is less than the maximum value, the CPU 300 repeats the process from S603 to S606.

The following description will be made on the assumption that the "target temperature" of the pre-heating control is set to "85°C". Furthermore, it is assumed that the temperature value "Tstart", the "wait time" and the "maximum value of the loop counter" are set to "80°C", "30 ms (0.03 seconds)" and "100", respectively.

In this case, in S601, the printing head 112 is heated to 85°C. Then, in S602, the loop counter value is set to "0". Then, in S603, the head temperature value of the printing head 112 is obtained. Then, in S604, it is determined whether the head temperature value of the printing head 112 is higher than 80°C.

In a case where the head temperature value of the printing head 112 is equal to or lower than 80°C, the first control (S601 to S604) is ended, and a second control is started. On the other hand, in a case where the head temperature value of the printing head 112 is higher than 80°C, in S605, wait processing is performed for 0.03 seconds. After the wait time elapses, in S606, the loop counter value is incremented. Then, in S607, it is determined whether the loop counter value is equal to or more than 100.

In a case where the loop counter value is less than 100, the process from S603 to S606 is repeated. In a case where the loop counter value is equal to or more than 100, the first control is ended, and the second control is started. That is, in a case where the cumulative wait time in S605 becomes 3 seconds or more, the first control is ended, and the second control is started.

This is the end of a specific example of the pre-heating control. Next, the protective tape detection control will be described.

In S608, the CPU 300 resets a wait counter value, which is a value for managing the number of cumulative waits in S617 described later, even in a case where a cooling loop (the process from S615 to S619 described later) is performed a plurality of number of times. For example, the wait counter value is set to "0".

In S609, the CPU 300 resets a detection flag that indicates the presence or absence of the protective tape. For example, the detection flag is set to "0".

In S610, the CPU 300 refers to the wait counter value stored in the ROM 301, and determines whether the wait counter value is less than a predetermined detection threshold. In a case where the wait counter value is equal to or more than the predetermined detection threshold, the processing of S611 is performed. On the other hand, in a case where the wait counter value is less than the predetermined detection threshold, the processing of S612 is performed.

In S611, the CPU 300 sets the detection flag that indicates that the protective tape remains on the printing head 112. For example, the detection flag is set to "1" to indicate that the protective tape remains.

In S612, the CPU 300 performs the refreshing processing and increments the number of executions of the refreshing processing. After the processing of S612 ends, the processing of S613 is performed.

In S613, the CPU 300 performs wait processing (wait after refreshing) for a predetermined time. The wait time in S613 can be a minimum time necessary.

In S614, the CPU 300 resets a cooling loop counter value, which is a value for managing the number of executions of the cooling loop from S615 to S620 described later. For example, the cooling loop counter value is set to "0".

In S615, the CPU 300 obtains the head temperature value (Thead).

In S616, the CPU 300 refers to the head temperature value (Thead) obtained in S615, and determines whether the head temperature value is more than the threshold (Tth). In a case where the head temperature value (Thead) is more than the threshold (Tth), the CPU 300 performs the processing of S617. On the other hand, in a case where the head temperature value (Thead) is equal to or less than the threshold (Tth), the CPU 300 performs the processing of S621.

In S617, the CPU 300 performs wait processing (cumulative wait processing) for a predetermined time.

In S618, the CPU 300 increments the wait counter value that indicates the number of executions of the cumulative wait processing in S617.

In S619, the CPU 300 increments the cooling loop counter value that indicates the number of executions of the cooling loop processing from S615 to S620.

In S620, the CPU 300 refers to the cooling loop counter value incremented in S619, and determines whether the cooling loop counter value is equal to or more than a predetermined maximum value. In a case where the cooling loop counter value is less than the maximum value, the CPU 300 repeats the process from S615 to S620. On the other hand, in a case where the cooling loop counter value is equal to or more than the maximum value, the CPU 300 performs the processing of S621.

In S621, the CPU 300 refers to the value indicating the number of executions of the refreshing processing in S612, and determines whether the value is equal to or more than a predetermined value. In a case where the number of executions of the refreshing processing is less than the predetermined number of times, the CPU 300 repeats the process from S610 to S621. On the other hand, in a case where the number of executions of the refreshing processing is equal to or more than the predetermined number of times, the CPU 300 performs the processing of S622.

In S622, the CPU 300 refers to the value indicated by the detection flag, and determines whether the detection flag is set. In a case where the detection flag is not set, the CPU 300 performs the processing of S623. On the other hand, in a case where the detection flag is set, the CPU 300 performs the processing of S624.

In S623, the CPU 300 stores, in the ROM 301, the determination result that indicates that the protective tape does not remain on the printing head 112. After the S623 ends, the CPU 300 performs the processing of S503 (see FIG. 5).

In S624, the CPU 300 stores, in the ROM 301, the determination result that indicates that the protective tape remains on the printing head 112. After the S624 ends, the CPU 300 performs the processing of S503 (see FIG. 5).

In the following, a specific example of the protective tape detection control will be described.

First, the wait counter value is set to "0" (S608). Then, "0" is set as the value of the detection flag (S609). In a case where the wait counter value is equal to or more than "6" (NO in S610), "1" is set as the value of the detection flag (S611). This means that the temperature of the printing head 112 is less likely to decrease while the process from S612 to S621 is being repeated. That is, the detection flag indicating "1" means that the possibility that the protective tape remains on the printing head 112 is high. On the other hand, in a case where the wait counter value is less than "6" (YES in S610), the refreshing operation is performed (S612).

For example, it is assumed that the energy applied to the ejection heaters 318 becomes higher than expected in a situation where the environmental temperature of the periphery of the printing apparatus 100 (see FIG. 1) is 40°C. In this case, if the number of times of the wait processing after the refreshing operation is less than six (that is, the wait counter value is less than "6"), the possibility that the protective tape is erroneously detected in a case where the protective tape does not remain is considered to be low. Thus, in S610 according to this embodiment, it is determined to perform the refreshing operation in a case where the wait counter value is less than "6".

After the refreshing operation is performed, wait processing is performed for 30 ms (S613). After the wait time of 30 ms elapses, the cooling loop counter value is set to "0" (S614). After the cooling loop counter value is set to "0", the head temperature value (Thead) of the printing head 112 is obtained (S615).

In a case where the head temperature value (Thead) is higher than 86°C (YES in S616), cumulative wait processing is performed for 30 ms (S617). After the cumulative wait is performed for 30 ms, the wait counter value is incremented (S618). After the wait counter value is incremented, the cooling loop counter value is incremented (S619).

After the cooling loop counter value is incremented, it is determined whether the cooling loop counter value is equal to or more than 100 (S620). In a case where the cooling loop counter value is less than 100, the cooling loop processing from S615 to S620 is repeated. On the other hand, in a case where the head temperature value (Thead) is lower than 86°C (NO in S616), or in a case where the cooling loop counter value is equal to or more than 100 (YES in S620), the processing of S621 is performed.

In a case where the refreshing operation of S612 is performed ten times (YES in S621), it is determined whether the value indicated by the detection flag is "0". On the other hand, in a case where the number of times of the refreshing operation of S612 is less than 10 (NO in S621), the process from S610 to S620 is repeated.

In a case where the value indicated by the detection flag is "0" (YES in S622), it is determined that the protective tape does not remain on the printing head 112. On the other hand, in a case where the value indicated by the detection flag is "1" (NO in S622), it is determined that the protective tape remains on the printing head 112.

In this way, by combining the first control and the second control, the presence or absence of the protective tape can be precisely detected. Note that the presence or absence of the protective tape is found at S611. Therefore, the determination in S621 may be omitted, and in a case where the determination result in S610 is negative, it may be determined that the protective tape remains, and the second control may be ended.

Referring back to FIG. 5, the process in FIG. 5 will be described again.

In S503, the CPU 300 refers to the determination result from S622 (see FIG. 6), and determines whether there is a possibility that the protective tape remains on the printing head 112. In a case where there is a possibility that the protective tape remains on at least one of the first printing head 107 and the second printing head 108, the CPU 300 performs the processing of S504. On the other hand, in a case where there is no possibility that the protective tapes remain on the first printing head 107 and the second printing head 108, the CPU 300 performs the processing of S508.

In S504, the CPU 300 resets a counter value indicating the consumed amount of ink for the printing head 112 for which there is a possibility that the protective tape remains. Note that this counter value indicates the estimated amount of consumed ink and does not necessarily agree with the actual consumed amount of ink. The protective tape detection control includes the refreshing operation. Therefore, each time the refreshing operation is performed, the counter value corresponding to the amount of ink consumed by the printing head 112 is incremented and stored in the RAM 302.

On the other hand, in a case where the protective tape is not removed, no ink is consumed in the refreshing operation. Therefore, in a case where it is determined that there is a possibility that the protective tape remains, the counter value indicating the consumed amount of ink is reset. In this way, the difference between the value of the actual consumed amount of ink and the displayed value or the like of the amount of ink can be reduced.

In S505, the CPU 300 subtracts the amount of ink consumed in the protective tape detection control from the value of the amount of waste ink indicated by an internal counter retained in the printing apparatus 100.

In S506, the CPU 300 outputs, from the notification section 319, a notification that indicates that there is a possibility that the protective tape is not removed from the printing head 112. In S506, for example, a first support screen 701 (see FIG. 7A) is displayed on the notification section 319.

FIG. 7A is a diagram showing an example of the first support screen 701 displayed on the notification section 319 according to this embodiment. With reference to FIG. 7A, a case will be described where the protective tapes on both the first printing head 107 and the second printing head 108 remain.

As shown in FIG. 7A, the notification section 319 displays the first support screen 701 for assisting the user to perform a job of removing the protective tape from each of the first printing head 107 and the second printing head 108. The first support screen 701 includes a text indicating that there is a possibility that the protective tape is not removed from each of the first printing head 107 and the second printing head 108.

FIG. 7B is a diagram showing an example of a second support screen 702 displayed on the notification section 319 according to this embodiment. With reference to FIG. 7B, a case will be described where only the protective tape on the second printing head 108 remains.

As shown in FIG. 7B, the notification section 319 displays the second support screen 702 for assisting the user to perform a job of removing the protective tape from the second printing head 108. The second support screen 702 includes a text indicating that there is a possibility that the protective tape is not removed from the second printing head 108.

FIG. 7C is a diagram showing an example of a third support screen 703 displayed on the notification section 319 according to this embodiment. With reference to FIG. 7C, a case will be described where only the protective tape on the first printing head 107 remains.

As shown in FIG. 7C, the notification section 319 displays the third support screen 703 for assisting the user to perform a job of removing the protective tape from the first printing head 107.

The third support screen 703 includes a text indicating that there is a possibility that the protective tape is not removed from the first printing head 107. For example, after seeing the first support screen 701 (see FIG. 7A), the user opens a cover (not shown) of the printing apparatus 100 (see FIG. 1, for example) and removes the printing head 112. Then, the user removes the protective tape, mounts the printing head 112 on the carriage 106 again, and closes the cover described above.

After the cover of the printing apparatus 100 is opened by the user, the opening of the cover may be detected, and animation of the printing head 112 being removed may be displayed on the notification section 319. In this way, the user can be prompted to remove the printing head 112.

After the printing head 112 is removed by the user, the removal may be detected, and animation of the protective tape being removed may be displayed on the notification section 319. In this way, the user can be prompted to remove the protective tape.

After the printing head 112 is mounted again, the mounting may be detected, and a text that prompts the user to close the cover may be displayed on the notification section 319. In this way, the user can be prompted to close the cover.

After any of the first support screen 701, the second support screen 702, or the third support screen 703 is displayed and the closing of the cover by the user is detected, the processing of S507 (see FIG. 5) is performed.

In the examples shown in FIGS. 7A to 7C, texts indicating that the protective tape(s) is not removed are displayed. However, a text notifying that there is a possibility that a nozzle is clogged may be displayed on the first support screen 701, the second support screen 702, or the third support screen 703. This is because in a case where a nozzle is clogged, an ejection failure is caused by the clogged nozzle, as in the case where the protective tape is not removed.

In S507, the CPU 300 refers to the type of ClnFlag stored in the memory of the printing head 112, and determines whether the printing head 112 is replaced (detached and attached). In a case where the printing head 112 is not replaced, the processing of S506 is repeated. On the other hand, in a case where the printing head 112 is replaced, the processing of S501 is repeated. After that, the process described with reference to FIG. 6 is performed, and in a case where it is determined in S503 that there is no protective tape, the processing of S508 is performed.

While the second support screen 702 (FIG. 7B) is displayed, the user may replace not only the second printing head 108 but also the first printing head 107. In such a case also, since the second printing head 108 is removed, it is assumed that the protective tape is removed from the second printing head 108, and it is determined that the printing heads 112 are replaced.

To the contrary, while the third support screen 703 (FIG. 7C) is displayed, the user may replace not only the first printing head 107 but also the second printing head 108. In such a case, since the first printing head 107 is removed, it is assumed that the protective tape is removed from the first printing head 107, and it is determined that the printing heads 112 are replaced.

In S508, the CPU 300 performs the recovery processing.

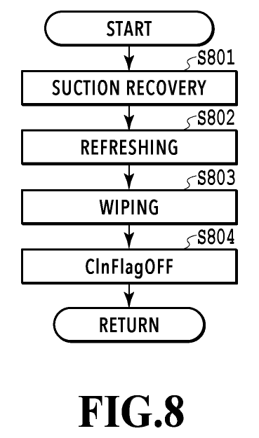

FIG. 8 is a diagram showing a subroutine of S508.

In S801, the CPU 300 performs processing for performing the suction recovery operation. Note that parameters indicating the speed and the amount of the suction recovery operation change with the contents indicated by ClnFlag described above.

In S802, the CPU 300 performs processing for performing the refreshing operation. Note that parameters indicating the type and the number of ink ejections of the refreshing operation change with the contents indicated by ClnFlag described above.

In S803, the CPU 300 performs processing for performing the wiping operation.

In S804, the CPU 300 turns off ClnFlag in the memory of each printing head.

This is the end of the subroutine of S508.

Referring back to FIG. 5, the process in FIG. 5 will be described again. After the processing of S508 ends, the CPU 300 ends the process of the flowchart of FIG. 5.

As described above, the printing apparatus 100 according to this embodiment can prevent excessive temperature rising and precisely detect the state of the printing head 112 by taking advantage of the original basic configuration, without needing an extra component.

By setting the threshold (Tth) at a temperature value that is not reached in a case where the printing head 112 is in the normal state and the heat at which cannot cause damage to the printing head 112, damage to the printing head 122 can be reduced, and the wait time occurs only in a case where a predetermined error has occurred.

Furthermore, the presence or absence of an error is determined based on the value of the wait counter (that is, the accumulated wait time in a plurality of times of refreshing). Therefore, compared with the case where the determination is made based on only the presence or absence of the wait time in one refreshing, the influence of an accidental event can be reduced. For example, in a case where an accidental event such as air entrainment occurs, the event can be prevented from being immediately erroneously detected as an error.

Therefore, the printing apparatus according to this embodiment can precisely detect the liquid ejection state of the printing section.

Furthermore, the printing apparatus according to this embodiment does not require an extra component used only for detecting a liquid ejection failure in the printing section. Therefore, compared with the printing apparatus that requires an extra component used only for detecting an error in the printing section, the printing apparatus according to this embodiment can easily detect the presence or absence of an error.

For example, there is a printing apparatus that detects no ink ejection, a droplet misdirection or the like by printing a test pattern and reading the print with a sensor that reads the test pattern. The printing apparatus of this type requires the sensor that reads the test pattern. Furthermore, the user is required to prepare a printing medium used only for printing of the test pattern. However, the printing apparatus according to this embodiment does not require such an extra component used only for detection of an error. The printing apparatus according to this embodiment can detect an error by using the detection results from the diode sensor and the thermistor provided for ejection control of the printing head.

Therefore, the printing apparatus according to this embodiment can easily detect the presence or absence of an error.

In a case where the environmental temperature of the periphery of the printing apparatus is particularly low, the determination result in S616 is more likely to be negative, so that it can be determined that there is no protective tape even in a case where the protective tape remains.

In such a case, the frequency at which the printing elements are driven can be increased to relatively increase the contributions of the heat quantity and the flowrate to the ink ejection. In a case where the driving frequency is set high, there is a possibility that the temperature of the printing head excessively rises.

In particular, if the frequency at which the printing elements are driven is excessively increased in a situation where the remaining amount of ink in the printing head is low, the possibility that the temperature of the printing head excessively rises is high. However, the printing apparatus according to this embodiment performs recovery from the liquid ejection failure without increasing the driving frequency of the printing elements.

Therefore, the printing apparatus according to this embodiment can prevent the temperature of the printing head from excessively rising. That is, the printing apparatus according to this embodiment can reduce the damage to the printing head.

### Modification of First Embodiment

In the following, a modification of the printing apparatus 100 (see FIG. 1) according to the first embodiment will be described with reference to the drawings.

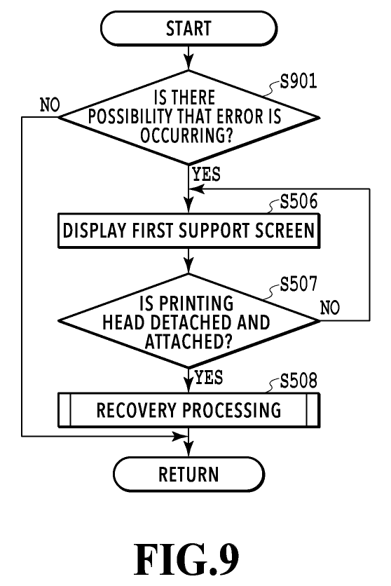

FIG. 9 is a diagram showing a modification of the flowchart including the recovery processing of FIG. 5.

The process of the flowchart shown in FIG. 9 is triggered in a case where the power supply of the printing apparatus 100 is turned off and then turned on again in the state where there is a possibility that an error is occurring in the printing head 112.

For example, assume that the user turns off the power supply of the printing apparatus 100 in a case where any of the screens shown in FIGS. 7A to 7C is displayed in the state where the protective tape is attached to the nozzle surface. After that, in a case where the power supply of the printing apparatus 100 is turned on again, the process of the flowchart of FIG. 9 is triggered.

As shown in FIG. 9, in S901, the CPU 300 determines, in a well-known manner, whether the power supply of the printing apparatus 100 is turned off in the state where there is a possibility that an error is occurring. For example, it is determined whether the power supply of the printing apparatus 100 is turned off in a case where any of the screens shown in FIGS. 7A to 7C is displayed.

In a case where the power supply of the printing apparatus 100 is turned off in the state where there is a possibility that an error is occurring, the processing of S506 (see FIG. 5) is performed. On the other hand, in a case where the power supply of the printing apparatus 100 is turned off in the state where there is no possibility that an error is occurring, the printing apparatus 100 according to this embodiment ends the process of this flowchart.

This is the end of the description of the flowchart according to this modification.

As described above, even if the power supply is turned off in the state where an error is not eliminated, the printing apparatus 100 according to this embodiment can notify again that the error is occurring in a case where the power supply is turned on again.

As described above, the printing apparatus 100 according to this modification repeats the routine from S610 to S620 in FIG. 6 until the refreshing operation is performed ten times. In the repetition process, the value of the wait counter is gradually incremented. In this case, the temperature of the printing head on which the protective tape remains and the printing head having run out of ink is less likely to decrease after the refreshing operation. Therefore, the determination result in S616 is less likely to be negative. As a result, the wait counter (S618) is incremented accordingly, and the value of the wait counter becomes larger. As a result, the detection flag is set in S611.

On the other hand, in a case where the protective tape is removed, and a sufficient amount of ink remains, the head temperature tends to quickly decrease after the refreshing operation. Therefore, before the cooling loop counter reaches an upper limit, the determination result in S616 becomes negative, and the subsequent refreshing operation is performed. Therefore, the loop process from S615 to S620 is exited without the loop counter reaching the upper limit, and the value of the wait counter does not substantially increase. As a result, ten refreshes end without the detection flag being set in S611.

Even if a situation where the head temperature is less likely to decrease because of accidental bubbling or the like after one refreshing operation, the detection flag is not set if the head temperature stably decreases after a plurality of refreshing operations other than the one refreshing operation. Therefore, in the protective tape detection control, the possibility that no ejection failure is occurring can be determined to be high.

That is, the printing apparatus according to this modification can precisely detect the presence or absence of an error in the printing section without being affected by an accidental change in the printing head, as with the technique according to Patent Literature 1.

### Second Embodiment

In the following, a printing apparatus according to a second embodiment of the technique of the present disclosure will be described with reference to the drawings. In the following, differences from the printing apparatus according to the first embodiment will be mainly described. The same components as those of the printing apparatus according to the first embodiment or components corresponding to those of the printing apparatus according to the first embodiment will be denoted by the same reference numerals, and descriptions thereof will be omitted.

Even if an instruction to perform a refreshing operation of preliminarily ejecting ink is input, the refreshing operation cannot be performed if a sufficient amount of ink remains in the printing head 112. In view of this, a printing apparatus 100 according to this embodiment (see FIG. 1) detects whether ink shortage (no-ink error) is occurring in the refreshing operation.

In a case where ink shortage occurs, even if the refreshing operation is performed, no ink is supplied to the printing section. Therefore, the temperature of the printing head raised in temperature by the refreshing operation is less likely to decrease compared with the case where ink shortage does not occur. That is, the method of detecting whether the protective tape remains according to the first embodiment can be adopted substantially without change as the method of detecting whether ink shortage is occurring.

The printing apparatus 100 according to this embodiment also obtains the head temperature value (Thead) each time the printing apparatus 100 performs the refreshing operation. In a case where the head temperature value (Thead) is higher than the threshold (Tth), the cumulative wait processing is performed until the head temperature value (Thead) decreases to the threshold (Tth) or lower. The wait time of the cumulative wait processing is summed while performing refreshing, and in a case where the cumulative time becomes more than a predetermined time, it is determined that there is a possibility that an error is occurring in the printing head 112.

The printing apparatus 100 according to this embodiment is primarily intended to recover the ink ejection performance of the nozzles by performing the refreshing operation. Thus, the printing apparatus 100 according to this embodiment does not perform the pre-heating processing.

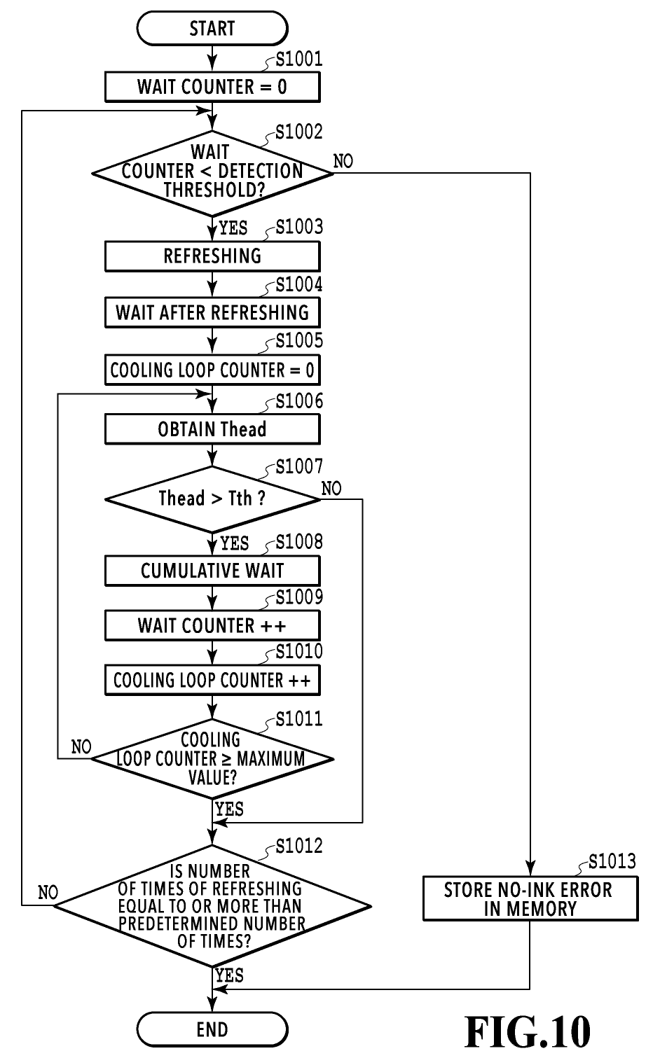

FIG. 10 is a flowchart showing an example of a refreshing process according to this embodiment. This process is performed for each printing head.

The process of the flowchart shown in FIG. 10 is triggered in a case where an instruction to perform the refreshing operation is input.

In S1001, the CPU 300 resets the wait counter value, which is a value for managing the cumulative wait time used for determining the presence or absence of ink. For example, the wait counter value is set to "0". After the processing of S1001, a loop from S1002 to S1012 starts.

In S1002, the CPU 300 compares the wait counter value and a detection threshold (described later), and determines whether the wait counter value is smaller than the detection threshold. For example, it is determined whether the wait counter value is smaller than 300.

In a case where the wait counter value is smaller than the detection threshold, the CPU 300 performs the processing of S1003. On the other hand, in a case where the wait counter value is equal to or more than the detection threshold, the CPU 300 stores, in the memory, information that there is no ink in the relevant printing head, and ends the refreshing process.

In S1003, the CPU 300 performs the refreshing process for performing the refreshing operation. In the refreshing operation according to this embodiment, 400 ink ejections are performed at 20 kHz.

In S1004, the CPU 300 performs wait processing for a predetermined time.

In S1005, the CPU 300 resets the cooling loop counter value, which is a value for managing the number of executions of the cooling loop described later. For example, the loop counter value is set to "0". After the processing of S1005, the cooling loop from S1006 to S1011 starts.

In S1006, the CPU 300 obtains the head temperature value (Thead).

In S1007, the CPU 300 compares the head temperature value (Thead) obtained in S1006 and the threshold (Tth), and determines whether the head temperature value (Thead) is more than the threshold (Tth). For example, in S1007, it is determined whether the head temperature is higher than 86°C. In a case where the head temperature value (Thead) is more than the threshold (Tth), the CPU 300 performs the processing of S1008. On the other hand, in a case where the head temperature value (Thead) is equal to or less than the threshold (Tth), the CPU 300 performs the processing of S1012.

In S1008, the CPU 300 performs cumulative wait processing for a predetermined time. For example, in S1008, wait processing is performed for 30 ms.

In S1009, the CPU 300 increments the wait counter value, which is a value used for the determination in S1002 described above.

In S1010, the CPU 300 increments the cooling loop counter value.

In S1011, the CPU 300 compares the cooling loop counter value obtained in S1010 and a predetermined maximum value, and determines whether the cooling loop counter value is equal to or more than the predetermined maximum value. For example, it is determined whether the cooling loop counter value is equal to or more than 300. In a case where the cooling loop counter value is equal to or more than the predetermined maximum value, the CPU 300 performs the processing of S1012. In a case where the cooling loop counter value is less than the predetermined maximum value, the CPU 300 repeats the process from S1006 to S1011.

In this way, in the loop process from S1006 to S1011, for example, wait processing is performed in units of 30 ms for up to 3 s until the temperature of the printing head 112 decreases to 86°C or lower.

In S1012, the CPU 300 refers to the number of executions of the refreshing operation, and determines whether the number of executions has reached a predetermined number of times (Y). In a case where the number of executions of the refreshing operation has reached Y, the process of the flowchart of FIG. 10 ends. That is, the refreshing operation is normally performed and ends. On the other hand, in a case where the number of executions of the refreshing operation is less than Y, the processing of S1012 is repeated. For example, in S1012, it is determined whether the refreshing operation has been performed 73 times.

In this way, the printing apparatus 100 according to this embodiment performs refreshing operation by ejecting ink 400 times at 20 kHz. Then, after the wait processing is performed for 30 ms, if the temperature of the printing head 112 is equal to or higher than 86°C, the wait processing is performed for 30 ms again. While such a cooling loop is repeated 73 times, in a case where the wait counter value becomes 300 or more (that is, the cumulative wait time becomes 9 s or more), in S1002, the CPU 300 determines that there is no ink.

In this way, the printing apparatus 100 according to this embodiment exits the loop, that is, stops the refreshing processing. On the other hand, if the 73 refreshing operations are completed in the state where the cumulative wait time is less than 9 s, it means that the desired refreshing processing is normally completed.

Note that as in S611 (see FIG. 6), the detection flag may be set, and it may be determined that there is no ink after the refreshing operation is performed 73 times. In the state where there is no ink, the head temperature is likely to significantly rise during execution of the refreshing operation, compared with the state where there is ink and the state where there is the protective tape.

In the state where there is no ink, the temperature of the printing head 112 is managed by providing a wait time. Therefore, the damage to the printing head 112 caused by heat does not pose a significant problem even if the loop is not exited in the middle of the loop. However, in the state where there is no ink, a cumulative wait time of several tens of seconds may occur in total. Therefore, in the state where there is no ink, occurrence of a downtime is prevented by exiting the loop in the middle of the loop.

Furthermore, a method of determining that there is no ink by physically measuring the remaining amount of ink with an internal counter, a sensor or the like of the printing apparatus 100 may be used. However, if the method of estimating the remaining amount of ink based on the temperature of the printing head 112 is adopted as in the printing apparatus 100 according to this embodiment, the presence or absence of ink can be detected without an extra component used only for detecting the presence or absence of ink.

In a case where a typical printing apparatus runs out of ink, the printing apparatus notifies the user that the printing head needs to be replaced or the ink needs to be added, for example. This notification is made regardless of the remaining amounts of other types of ink, in a case where one type of ink is empty among a plurality of types of ink.

At the same time, the user may intensively use the ink having run out and not use much of the other types of ink. If the typical notification of ink shortage is made to the user who uses the ink in this way, the user is required to replace the printing head containing a type of ink the user will not use, for example. Considering such a use case, the printing apparatus is preferably configured such that even if some of a plurality of types of ink is empty, the printing apparatus can continue operating by using the remaining types of ink.

In view of this, the printing apparatus 100 according to this embodiment is configured such that the printing apparatus can be set to a "no-ink mode" in which even if some of a plurality of types of ink is empty, the printing apparatus continues operating by using the remaining types of ink.

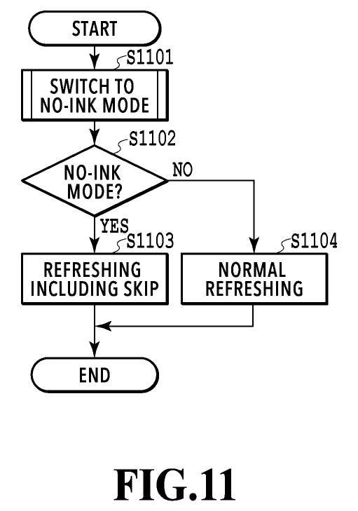

FIG. 11 is a flowchart showing a transition to the no-ink mode and a subsequent process in the case where a new refreshing instruction is input to the printing apparatus 100.

In S1101, the CPU 300 performs switching processing to the no-ink mode.

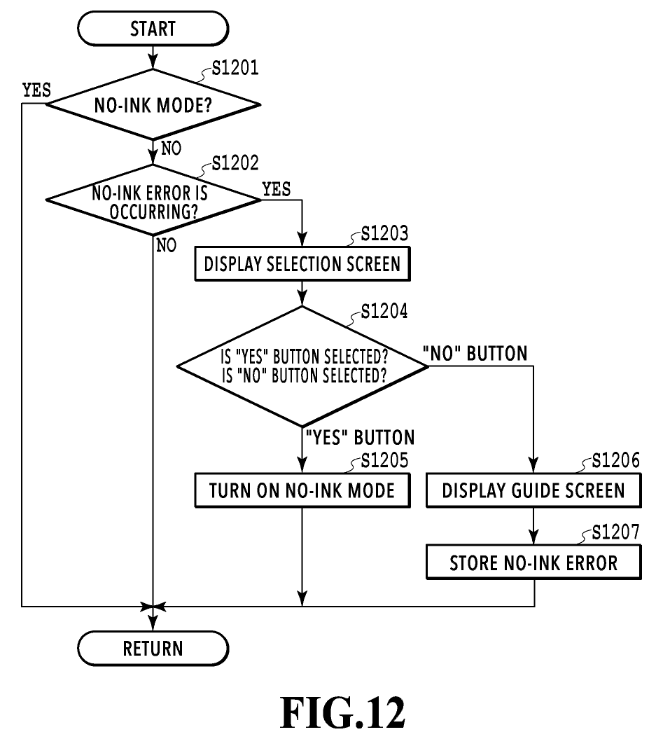

FIG. 12 is a diagram showing a subroutine of S1101 according to this embodiment.

In S1201, the CPU 300 refers to a flag indicating the "no-ink mode" stored in the ROM 301. In a case where the flag is already set, the CPU 300 performs the processing of S1102 (see FIG. 11). On the other hand, in a case where the flag of the no-ink mode is not set yet, the CPU 300 performs the processing of S1202.

In S1202, the CPU 300 refers to a history of ink shortages (no-ink errors) stored in the ROM 301. In a case where no history indicating ink shortage of both the first printing head 107 and the second printing head 108 is stored in the ROM 301, the CPU 300 ends this subroutine. On the other hand, in a case where a history indicating ink shortage of the first printing head 107 and/or the second printing head 108 is stored in the ROM 301, the CPU 300 performs the processing of S1203.

In S1203, the CPU 300 performs processing of displaying on the notification section 319 a selection screen 1300 for selecting whether to switch to the no-ink mode (see FIG. 13).

FIG. 13 is a diagram showing an example of the selection screen 1300 according to this embodiment. In the following, a case will be described in which the color ink in the first printing head 107 is empty, and the black ink in the second printing head 108 remains.

As shown in FIG. 13, the selection screen 1300 includes a text indicating that the color ink is empty and a question to ask whether to switch to the no-ink mode. The selection screen 1300 includes a "YES" button 1301 for selecting to switch to the no-ink mode and a "NO" button 1302 for selecting not to switch to the no-ink mode.

Referring back to FIG. 12, the process in FIG. 12 will be described again.

In S1204, the CPU 300 determines whether to turn on the no-ink mode according to the type of the button selected on the selection screen 1300 displayed. In a case where the "YES" button 1301 is selected on the selection screen 1300 displayed, the CPU 300 performs the processing of S1205. On the other hand, in a case where the "NO" button 1302 is selected on the selection screen 1300 displayed, the CPU 300 performs the processing of S1206.

In S1205, the CPU 300 performs processing for turning on the no-ink mode. For example, settings are made such that the ejection for printing, the refreshing, the recovery processing and the like using the first printing head 107 determined to contain no ink are not performed, and the ejection for printing, the refreshing, the recovery processing and the like using only the second printing head 108 are performed. After the processing of S1205, the CPU 300 performs the processing of S1102 (see FIG. 11).

In S1206, the CPU 300 performs processing of displaying on the notification section 319 a guide screen 1400 for prompting to replace the printing head determined to contain no ink (see FIG. 14).

FIG. 14 is a diagram showing an example of the guide screen 1400 according to this embodiment. FIG. 14 shows an example in which replacement of the first printing head 107 is prompted. As shown in FIG. 14, the guide screen 1400 includes a text indicating that the color ink in the first printing head 107 is empty and a text for prompting replacement of the first printing head 107.

Referring back to FIG. 12, the process in FIG. 12 will be described again. After the processing of S1206 ends, the CPU 300 performs the processing of S1207.

In S1207, the CPU 300 stores, in the ROM 301, a history indicating that there is no ink in the first printing head 107. After the processing of S1207, the CPU 300 ends the process of the flowchart of FIG. 12.

Referring back to FIG. 11, the process in FIG. 11 will be described again.

In S1102, the CPU 300 refers to the flag indicating whether the no-ink mode has been turned on stored in the ROM 301, and determines whether the no-ink mode has been turned on. In a case where the no-ink mode has been turned on, the CPU 300 performs the processing of S1103. In a case where the no-ink mode has not been turned on, the CPU 300 performs the processing of S1104.

In S1103, the CPU 300 performs the refreshing processing on the printing head excluding the printing head determined to contain no ink. That is, in a case where the color ink in the first printing head 107 is empty, and the black ink in the second printing head 108 remains, the refreshing processing is not performed on the first printing head 107. In this case, however, the refreshing operation described above with reference to FIG. 10 is performed only on the second printing head 108. After S1103 ends, the CPU 300 ends the process of this flowchart according to this embodiment.

In S1104, the CPU 300 performs the normal refreshing operation (that is, the refreshing operation described above with reference to FIG. 10 on both the first printing head 107 and the second printing head 108). After S1104 ends, the CPU 300 ends the process of this flowchart according to this embodiment.

As described above, the printing apparatus 100 according to this embodiment continues the refreshing processing in a case where the wait counter value is smaller than a threshold. The refreshing processing in this case ends in a case where the temperature of the printing head 112 decreases to a predetermined value or lower and a predetermined number of refreshing operations are performed. On the other hand, in a case where the wait counter value is equal to or greater than the threshold, the refreshing processing is interrupted, and a transition to the no-ink mode is possible.

In a case where the refreshing processing is performed in the no-ink mode, the refreshing operation on the printing head 112 having run out of ink is not performed. Therefore, occurrence of a downtime and incrementation of the value indicating the amount of waste ink can be prevented. In addition, the ease of use for users who intensively use a particular type of ink can be improved.

Therefore, the printing apparatus 100 according to this embodiment can perform appropriate refreshing processing on each of a plurality of printing heads even if any of the plurality of printing head runs out of ink.

### First Modification of Printing Apparatus 100 according to Second Embodiment

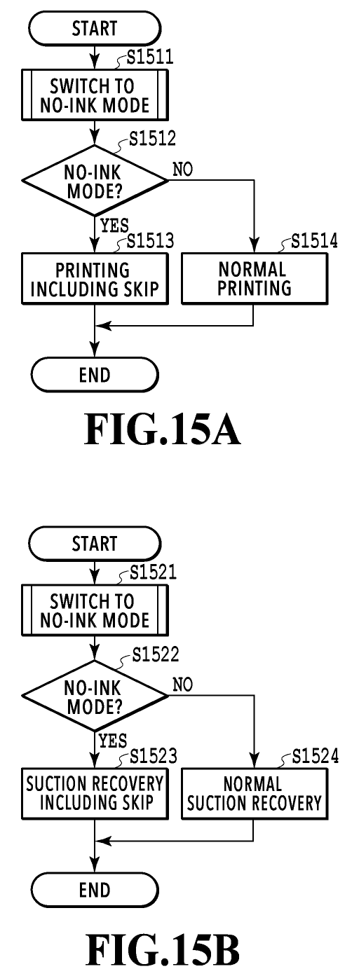

FIG. 15A is a diagram showing a first modification of S1013. Specifically, FIG. 15A is a flowchart showing a transition to the no-ink mode and a subsequent process in the case where an instruction to perform printing is input.

In the example in FIG. 11, in a case where at least any one of the two printing heads runs out of ink, the refreshing processing for the printing head is skipped. In a case where one of the printing heads runs out of ink, the printing apparatus 100 according to this modification prints an image by using only the other printing head.

In FIG. 15A, the process from S1511 to S1512 is the same as the process from S1101 to S1102 in FIG. 11.

In S1512, the CPU 300 refers to the flag indicating whether the no-ink mode has been turned on stored in the ROM 301, and determines whether the no-ink mode has been turned on. In a case where the no-ink mode has been turned on, the CPU 300 performs the processing of S1513. In a case where the no-ink mode has not been turned on, the CPU 300 performs the processing of S1514.

In S1513, the CPU 300 performs the printing processing using the printing head excluding the printing head determined to contain no ink. For example, in a case where the color ink in the first printing head 107 is empty, and the black ink in the second printing head 108 remains, color data is converted into black data, and the printing is performed using only the second printing head 108.

To the contrary, in a case where the black ink in the second printing head 108 is empty, and the color ink in the first printing head 107 remains, black data is converted into color data, and the printing is performed using only the first printing head 107. After S1513 ends, the CPU 300 ends the process of the flowchart according to this modification.

In S1514, the CPU 300 performs the normal printing processing. That is, the normal printing using both the first printing head 107 and the second printing head 108 is performed. After S1514 ends, the CPU 300 ends the process of the flowchart according to this modification.

As described above, the printing apparatus 100 according to this modification performs printing control using only the other printing head in a case where one printing head runs out of ink. With this configuration, the same effects as those in the example shown in FIG. 11 can be achieved.

### Second Modification of Printing Apparatus 100 according to Second Embodiment

FIG. 15B is a diagram showing a second modification of S1013. Specifically, FIG. 15B is a flowchart showing a transition to the no-ink mode and a subsequent process in the case where an instruction to perform the recovery processing is input.

In the example in FIG. 11, in a case where the color ink in one printing head is empty, the refreshing processing for the printing head is skipped. In this modification, in a case where one printing head runs out of ink, only the suction recovery processing for the other printing head is performed.

In FIG. 15B, the process from S1521 to S1522 is the same as the process from S1101 to S1102 in FIG. 11.

In S1522, the CPU 300 refers to the flag indicating whether the no-ink mode has been turned on stored in the ROM 301, and determines whether the no-ink mode has been turned on. In a case where the no-ink mode has been turned on, the CPU 300 performs the processing of S1523. In a case where the no-ink mode has not been turned on, the CPU 300 performs the processing of S1524.

In S1523, the CPU 300 performs the suction recovery processing on the printing head excluding the printing head determined to contain no ink. For example, in a case where the color ink in the first printing head 107 is empty, and the black ink in the second printing head 108 remains, the suction recovery processing is performed only on the second printing head 108. After S1523 ends, the CPU 300 ends the process of the flowchart according to this modification.

In S1524, the CPU 300 performs processing for performing the normal suction recovery operation. That is, the suction recovery processing is performed on all the printing heads. After S1524 ends, the CPU 300 ends the process of the flowchart according to this modification.

As described above, the printing apparatus 100 according to this modification performs the suction recovery operation on only the other printing head in a case where one printing head runs out of ink. With this configuration, the same effects as those in the example shown in FIG. 11 can be achieved.

### Third Modification of Printing Apparatus 100 according to Second Embodiment

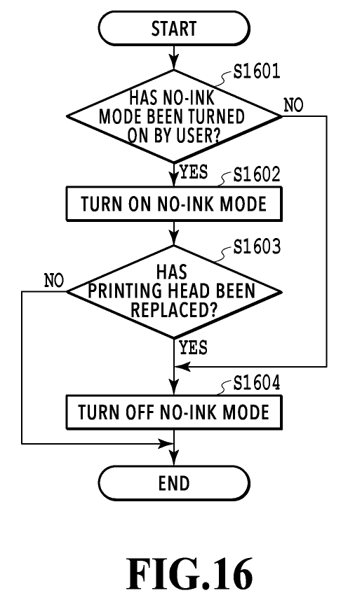

FIG. 16 is a diagram showing a modification of S1101.

In the example in FIG. 12, whether the printing apparatus is in the no-ink mode is determined (S1201) before the user selects the no-ink mode (S1204). However, the printing apparatus may be configured such that the no-ink mode is actively set by the user selecting the no-ink mode.

In S1601, the CPU 300 refers to the contents stored in the ROM 301, and determines whether the no-ink mode has been turned on by the user. In a case where the no-ink mode has been turned on by the user, the CPU 300 performs the processing of S1602. On the other hand, in a case where the no-ink mode has been turned off by the user, the CPU 300 performs the processing of S1604.

In S1602, the CPU 300 turns on the no-ink mode. After S1602, the processing of S1603 is performed.

In S1603, the CPU 300 refers to the type of ClnFlag, and determines whether the printing head has been replaced. In a case where ClnFlag indicates "H", the CPU 300 performs the processing of S1604. On the other hand, in a case where ClnFlag indicates the other type than "H", the CPU 300 ends this subroutine.

In S1604, the CPU 300 the CPU 300 turns off the no-ink mode. After S1604, the CPU 300 ends this subroutine.

As described above, by determining whether the no-ink mode has been turned on by the user before determining the presence or absence of ink, the user can actively set the no-ink mode.

### Third Embodiment

In the following, a printing apparatus according to a third embodiment of the technique of the present disclosure will be described with reference to the drawings. In the following, differences from the printing apparatuses according to the first and second embodiments will be mainly described. The same components as those of the printing apparatuses according to the first and second embodiments or components corresponding to those of the printing apparatuses according to the first and second embodiments will be denoted by the same reference numerals, and descriptions thereof will be omitted.

In the example in FIG. 6, only the presence or absence of the protective tape is detected. However, an error detection process combining detection of the presence or absence of the protective tape and detection of the presence or absence of ink may be performed.

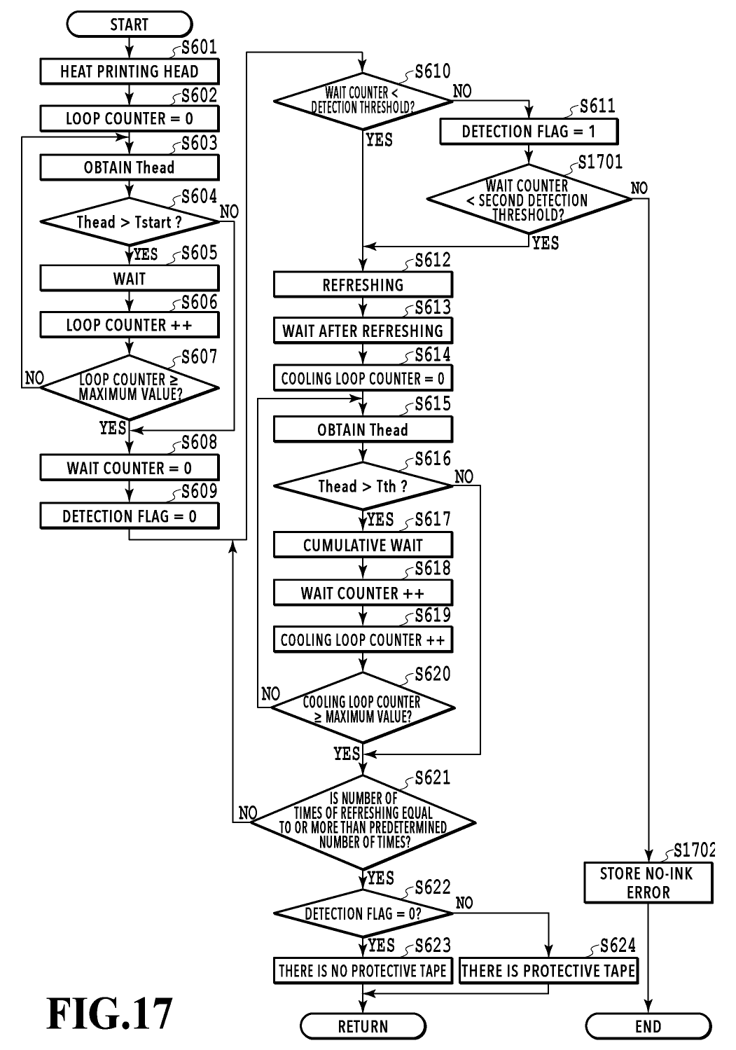

FIG. 17 is a diagram showing an example of a protective tape detection process according to this embodiment.

As shown in FIG. 17, in the error detection process according to this embodiment, the determination in S610 is performed. In a case where the determination result in S610 is "YES", the processing of S612 is performed. That is, in this case, the CPU 300 determines that the printing head 112 is in the normal state. On the other hand, in a case where the determination result in S610 is "NO", the processing of S611 is performed. After the detection flag is set to 1 in S611, the processing of S1701 is performed.

In S1701, the CPU 300 refers to the wait counter value and a second detection threshold stored in the ROM 301, and determines whether the wait counter value is less than the second detection threshold. The second detection threshold is a value greater than the threshold used in the comparison with the wait counter value in S610. In a case where the wait counter value is less than the second detection threshold, the processing of S612 is performed. In this case, the process following S612 is performed in the state where the detection flag is set in S611. Therefore, after the loop of the refreshing operation from S612 to S621 is performed a predetermined number of times, the CPU 300 determines that the protective tape remains (NO in S622). On the other hand, in a case where the wait counter value is equal to or more than the second detection threshold, the processing of S1702 is performed.

In S1702, the CPU 300 stores a history indicating a no-ink error (ink shortage) in the memory of the relevant printing head and/or the ROM 301. After S1702 ends, the CPU 300 ends the process of the flowchart of FIG. 17. In this case, the CPU 300 determines that no ink remains in the printing head 112. Therefore, the refreshing operation in S612 is not performed, and the loop from S615 to S620 is also not performed.

In this way, the state of the nozzles and the flowrate of ink may be precisely determined by arbitrarily combining the detection processing including no exit from the loop shown in FIG. 6 and the detection processing including an exit from the loop shown in FIG. 10.

According to this method, the state of the printing head 112 and the nozzles can be precisely detected while reducing excessive temperature rise in the printing head 112. For example, by detecting the presence or absence of the protective tape, the ease of use in set-up can be improved, and the difference between the counter value of the consumed amount of ink and the actual amount of ink can be reduced.

Furthermore, by detecting whether a sufficient amount of ink remains, the user can be prompted to perform ink refill or switch to the no-ink mode in which a particular type of ink is used.

Furthermore, information indicating an irreversible state of the printing head 112 may be stored in the ROM 301. For example, the protective tape is unlikely to be attached again once the user removes the protective tape, and the amount of ink contained in the printing head 112 is unlikely to increase. Thus, in a case where it is determined that no protective tape is attached to the printing head 112, the determination result may be stored in the ROM 301 so that the frequency of the detection process can be reduced.

Furthermore, in view of the fact that the temperature of the printing head 112 is affected by the ambient environmental temperature, various parameters referred to in a case where performing determination processing may be appropriately changed according to the ambient environmental temperature. In this case, however, it should be noted that if the precision of measurement of the ambient environmental temperature is low, the precision of detection of the state of the printing head 112 is affected.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The printing apparatus 100 in FIG. 1 uses the disposable printing head 112 having a print head and an ink tank integrated with each other. However, the technique of the present disclosure can be applied to a printing apparatus provided with an ink tank that is separately replaced.

Furthermore, in the example of S1603 in FIG. 16, the presence or absence of replacement of the printing head 112 is determined. However, in the case where a continuous ink supply system-type (CISS-type) printing apparatus is used, whether a sufficient amount of ink remains in the ink tank, rather than whether the printing head 112 has been replaced, can be determined. With such a configuration, the technique of the present disclosure can be applied to the CISS-type printing apparatus.

In the example in FIG. 14, since the disposable head having the ink tank and the print head integrated with each other is used, a text prompting to replace the printing head 112 is displayed. However, the representation to promote ink refill varies with the type of the printing apparatus. For example, in the case of the CISS-type printing apparatus, the representation to prompt ink refill is a message to promote injection of ink. In the case of a cartridge-type printing apparatus, the representation to promote ink refill is a message to prompt replacement of the ink cartridge.

In S622 in FIG. 6, in a case where the detection flag is set, it is determined that it is difficult to eject ink because the protective tape is still attached to the printing head. However, if the threshold (Tth) is set at 86°C, it can also be determined that it is difficult to eject ink because there is a nozzle clogged.

Furthermore, the orders of the steps in each flowchart described above can be changed as required. Furthermore, a plurality of steps in each flowchart described above may be performed at the same time. For example, the recovery processing may be performed while the first support screen 701 is displayed. And the user seeing the first support screen 701 may interrupt the recovery processing and perform replacement of the printing head 112. In that case, after the replacement of the printing head 112, the first support screen 701 may stop being displayed, and the interrupted recovery processing may be resumed.

The printing apparatus according to the present disclosure can precisely detect the liquid ejection state of the printing section.

This application claims the benefit of Japanese Patent Application No. 2025-063921, filed Apr. 8, 2025, which is hereby incorporated by reference herein in its entirety.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A printing apparatus, comprising:
a printing unit of ejecting a liquid;
a temperature detection unit of detecting a temperature of the printing unit;
a refreshing unit of performing a refreshing operation in which the printing unit ejects the liquid at a predetermined frequency;
a first processing execution unit of performing first processing of waiting by until a detected temperature of the printing unit after the refreshing operation detected by the temperature detection unit becomes equal to or lower than a predetermined threshold temperature;
a second processing execution unit of performing second processing in which the refreshing operation and the first processing are repeated a first number of times;
a counting unit of counting a cumulative value of a wait time in the second processing; and
a determination unit of determining that the printing unit is in a state where it is difficult to eject the liquid in a case where the cumulative value in the second processing becomes equal to or more than a threshold.

2. The printing apparatus according to claim 1, wherein in the first process, third processing is performed a second number of times, the third processing including waiting by for a predetermined time in a case where the detected temperature of the printing unit after the refreshing operation is higher than the predetermined threshold temperature and not including waiting by in a case where the detected temperature is lower than the threshold temperature.

3. The printing apparatus according to claim 2, wherein in a case where the detected temperature is lower than the threshold temperature, repetition of the third processing is interrupted before the second number of times is reached.

4. The printing apparatus according to claim 1, wherein the threshold temperature is higher than a normal temperature suitable for ejection of the liquid by the printing unit.

5. The printing apparatus according to claim 1, wherein in a case where it is determined that the printing unit is in a state where it is difficult to eject the liquid, the second processing is interrupted.

6. The printing apparatus according to claim 1, further comprising:
a pre-heating unit of performing pre-heating processing of heating the printing unit to a target temperature before the second processing is performed.

7. The printing apparatus according to claim 6, wherein the target temperature is higher than a normal temperature suitable for ejection of the liquid by the printing unit.

8. The printing apparatus according to claim 6, wherein the target temperature is lower than the threshold temperature.

9. The printing apparatus according to claim 6, wherein the second processing execution unit performs the second processing after a predetermined time elapses after the pre-heating unit performs the pre-heating processing.

10. The printing apparatus according to claim 6, wherein the second processing execution unit performs the second processing after the temperature of the printing unit detected by the temperature detection unit decreases to a predetermined temperature after the pre-heating processing.

11. The printing apparatus according to claim 10, wherein the predetermined temperature is higher than a normal temperature suitable for ejection of the liquid by the printing unit.

12. The printing apparatus according to claim 1, further comprising:
a notification unit of making a notification to a user in a case where the determination unit determines that the printing unit is in a state where it is difficult to eject the liquid.

13. The printing apparatus according to claim 12, wherein the notification unit notifies the user that a protective tape for protecting the printing unit is attached to the printing unit or a nozzle of the printing unit is clogged.

14. The printing apparatus according to claim 12, wherein the notification unit notifies the user that there is no liquid remaining in the printing unit.

15. The printing apparatus according to claim 1, wherein in the second process, the determination unit
determines that a nozzle of the printing unit is clogged or a protective tape covering a nozzle of the printing unit is attached to the printing unit in a case where the cumulative value equal to or more than a first threshold and is less than a second threshold that is greater than the first threshold, and
determines that there is no remaining liquid in a case where the cumulative value is equal to or more than the second threshold.

16. The printing apparatus according to claim 1, further comprising:
a recovery unit of performing recovery processing for recovering a performance of the printing unit,
wherein the recovery unit performs the recovery processing after the second processing execution unit performs the second processing.

17. The printing apparatus according to claim 13, wherein in a case where a power supply of the printing apparatus is turned off while the notification unit is making the notification, the notification unit makes the notification again after the power supply of the printing apparatus is turned on again.

18. The printing apparatus according to claim 13, wherein in a case where the determination unit determines that the printing unit is in a state where it is difficult to eject the liquid, the second processing is interrupted, and
in a case where detachment and attachment of the printing unit are performed while the notification unit is making the notification, the second processing is resumed.

19. The printing apparatus according to claim 16, further comprising:
a management unit of managing a consumed amount of liquid in the printing unit,
wherein in a case where the determination unit determines that the printing unit is in a state where it is difficult to eject the liquid, the management unit resets a consumed amount of liquid estimated to be consumed in the second processing.

20. The printing apparatus according to claim 19, wherein the printing unit includes a plurality of printing heads each of which ejects a different type of liquid,
the printing apparatus further comprises a storage section that stores, as a waste liquid counter value, a consumed amount of liquid consumed in the recovery processing for each of the plurality of printing heads, and
the management unit
subtracts the waste liquid counter value for a printing head among the plurality of printing heads that is determined to be in a state where it is difficult to eject a liquid from a sum of the waste liquid counter values, and
resets the waste liquid counter value for the printing head.

21. The printing apparatus according to claim 20, wherein the printing unit includes a plurality of the printing units that eject different types of liquids,
the temperature detection unit, the refreshing unit, the first processing execution unit, the second processing execution unit, the counting unit, and the determination unit are provided for each of the plurality of printing units, and
the printing apparatus further comprises:
a transition unit of making the printing apparatus transition from a first mode to a second mode in a case where at least one of the plurality of determination units determines that it is difficult to eject a liquid.

22. The printing apparatus according to claim 21, wherein the first mode is a mode in which all of the plurality of printing units are allowed to eject a liquid, and
the second mode is a mode in which among the plurality of printing units, printing unit determined by the determination unit to be in a state it is difficult to eject a liquid is not allowed to eject a liquid, and the other printing unit are allowed to eject a liquid.

23. The printing apparatus according to claim 22, wherein in the second mode, the printing unit ejects a liquid from only a printing head in which a liquid remains among the plurality of printing heads.

24. The printing apparatus according to claim 21, wherein the first mode is a mode in which a liquid is capable of being sucked from all of the plurality of printing units, and
the second mode is a mode in which a liquid is not sucked from printing unit among the plurality of printing units that is determined by the determination unit to be in a state where it is difficult to eject a liquid, and a liquid is capable of being sucked from the other printing unit.

25. The printing apparatus according to claim 21, further comprising:
a management unit of managing a consumed amount of liquid in the printing unit,
wherein in the second mode, for the printing unit among the plurality of printing units that is determined by the determination unit to be in a state where it is difficult to eject a liquid, the consumed amount of liquid in the printing unit is not counted.

26. The printing apparatus according to claim 21, wherein in a case where the printing head is replaced, the transition unit switches a control on the plurality of printing heads from the second mode to the first mode.

27. The printing apparatus according to claim 21, wherein in a case where the printing head is replaced, the transition unit switches a control on the plurality of printing heads from the second mode to the first mode according to a selection by a user.

28. The printing apparatus according to claim 21, wherein in a case where liquid refill is performed in the second mode, the transition unit switches a control on the printing head from the second mode to the first mode.

29. The printing apparatus according to claim 21, wherein in a case where liquid refill is performed in the second mode, the transition unit switches a control on the printing head from the second mode to the first mode according to a selection by a user.

30. The printing apparatus according to claim 22, further comprising:
a specific information storage unit of storing information specific to the printing head,
wherein the specific information storage unit stores a result of the determination by the determination unit in association with the printing head.

31. The printing apparatus according to claim 30, wherein in a case where the information stored in the specific information storage unit indicates that a protective tape is attached to the printing head, the first processing and the second processing are not performed.

32. A control method for a printing apparatus including a printing unit of ejecting a liquid, the control method comprising the step of:
detecting a temperature of the printing unit;
performing a refreshing operation in which the printing unit ejects the liquid at a predetermined frequency;
performing first processing of waiting by until a detected temperature of the printing unit after the refreshing operation becomes equal to or lower than a predetermined threshold temperature;
performing second processing in which the refreshing operation and the first processing are repeated a first number of times;
counting a cumulative value of a wait time in the second processing; and
determining that the printing unit is in a state where it is difficult to eject the liquid in a case where the cumulative value in the second processing becomes equal to or more than a threshold.

33. A non-transitory computer-readable storage medium having computer-executable instructions for causing a computer to perform steps comprising:
detecting a temperature of a printing unit;
performing a refreshing operation in which the printing unit ejects a liquid at a predetermined frequency;
performing first processing of waiting by until a detected temperature of the printing unit after the refreshing operation becomes equal to or lower than a predetermined threshold temperature;
performing second processing in which the refreshing operation and the first processing are repeated a first number of times;
counting a cumulative value of a wait time in the second processing; and
determining that the printing unit is in a state where it is difficult to eject the liquid in a case where the cumulative value in the second processing becomes equal to or more than a threshold.
